(19) United States
(12) Patent Application Publication
(10) Pub. No.: US 2024/0418512 A1
(43) Pub. Date: Dec. 19, 2024

(54) MULTI-SEGMENT PRECISION CLOSED-LOOP CONTROL

(71) Applicant: The Boeing Company, Arlington, VA (US)

(72) Inventors: Richard PEPE, Redondo Beach, CA (US); Andrew WALSH, Redondo Beach, CA (US); Reid REYNOLDS, Huntsville, AL (US)

(73) Assignee: The Boeing Company, Arlington, VA (US)

(21) Appl. No.: 18/336,235

(22) Filed: Jun. 16, 2023

(51) Int. Cl. G01C 21/24; G05D 1/46

(52) U.S. Cl. CPC G01C 21/24; G05D 1/46

(57) ABSTRACT

Techniques for maneuvering a space vehicle are presented. The techniques can include: obtaining a representation, in a computer, of a multi-segment planned position, planned velocity, and planned acceleration of the space vehicle along a planned continuous trajectory; tracking, using at least one navigation sensor, an indication of an actual position, actual velocity, and actual acceleration of the space vehicle; and maneuvering the space vehicle, using a closed-loop controller, and based on the tracking, to return to the planned position, planned velocity, and planned acceleration.

### GOVERNMENT SUPPORT

This invention was made with United States Government support. The government has certain rights in the invention.

### FIELD

This disclosure relates generally space vehicle maneuvering.

### BACKGROUND

Spacecraft orbits are maintained and adjusted by executing ΔV (“delta vee”) maneuvers, which impart a prescribed acceleration over a prescribed interval of time in a prescribed direction, yielding a net change in velocity. Many guidance algorithms are available to plan these maneuvers. Some assume impulsive thrust (instantaneous change in velocity), which is a reasonable approximation for short duration “burns”. Others solve precisely for burn duration given finite thrust levels.

Errors tend to accumulate over a given orbit maneuver interval. Existing approaches generally burn the engines at maximum thrust until the desired ΔV has been achieved. But there are many possible errors in the net acceleration (e.g., engine thrust variance, mass variance, and/or off-pulsing engines to maintain attitude control) that can yield an incorrect ΔV magnitude for a time-based maneuver. Utilization of an accelerometer to measure the as-executed ΔV can improve the results, but can still yield a burn duration that executes faster or slower than predicted, imparting errors on the final orbit.

Existing techniques typically use subsequent trim burns to reduce the error, but these may not be appropriate for time critical scenarios. Furthermore, accelerometer feedback does not utilize any on-board navigation hardware during execution that may be available to adjust the burn.

### SUMMARY

According to various embodiments, a non-transitory computer readable medium is presented. The non-transitory computer readable medium comprises instruction that, when executed by an electronic processor, configure the electronic processor to implement a method of maneuvering a space vehicle by performing actions comprising: obtaining a representation in a computer of a multi-segment planned position, planned velocity, and planned acceleration of the space vehicle along a planned continuous trajectory; tracking, using at least one navigation sensor, an indication of an actual position, actual velocity, and actual acceleration of the space vehicle; and maneuvering the space vehicle, using a closed-loop controller, and based on the tracking, to return to the planned position, planned velocity, and planned acceleration.

Various optional features of the above embodiments include the following. The representation may include a plurality of polynomial segments. The at least one navigation sensor may include at least one of: a GPS sensor, a fiducial marker sensor, a star tracker, an earth sensor, or a range finder. The planned continuous trajectory may include an orbit of the space vehicle about a planet. The planned continuous trajectory may include a docking of the space vehicle with another space vehicle. The multi-segment planned position, planned velocity, and planned acceleration may include a burn segment and a drift segment, and wherein the maneuvering occurs during the drift segment. The tracking may include using feedback data and feed-forward data. The obtaining may occur prior to beginning traversal of the planned continuous trajectory. The maneuvering may correct for an accelerometer inaccuracy. The at least one navigation sensor may include an on-board sensor.

According to various embodiments, a system for maneuvering a space vehicle is presented. The system includes: an electronic processor; and a non-transitory computer readable communicatively coupled to the electronic processor, the non-transitory computer readable medium comprising instructions that, when executed by the electronic processor, configure the electronic processor to perform actions comprising: obtaining a representation of a multi-segment planned position, planned velocity, and planned acceleration of the space vehicle along a planned continuous trajectory; tracking, using at least one navigation sensor, an indication of an actual position, actual velocity, and actual acceleration of the space vehicle; and maneuvering the space vehicle, using a closed-loop controller, and based on the tracking, to return to the planned position, planned velocity, and planned acceleration.

Various optional features of the above embodiments include the following. The representation may include a plurality of polynomial segments. The at least one navigation sensor may include at least one of: a GPS sensor, a fiducial marker sensor, a star tracker, an earth sensor, or a range finder. The planned continuous trajectory may include an orbit of the space vehicle about a planet. The planned continuous trajectory may include a docking of the space vehicle with another space vehicle. The multi-segment planned position, planned velocity, and planned acceleration may include a burn segment and a drift segment, and wherein the maneuvering occurs during the drift segment. The tracking may include using feedback data and feed-forward data. The obtaining may occur prior to beginning traversal of the planned continuous trajectory. The maneuvering may correct for an accelerometer inaccuracy. The at least one navigation sensor may include an on-board sensor.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram of a space vehicle according to various embodiments;

FIG. 2 is a schematic diagram of a planned continuous trajectory of a space vehicle according to various embodiments; and

FIG. 3 is a flow chart illustrating a method of maneuvering a space vehicle according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Existing techniques for spacecraft maneuvering frequently rely on ground-based thruster performance calibrations to compute open-loop orbit control maneuvers, which are less robust than closed-loop methods due to uncertainties (e.g., wet mass, mass distribution, fuel slosh, thruster alignments, thruster performance variation, etc.). Traditional algorithms typically rely on extra thrusters to minimize use of ΔV thrusters for attitude/momentum control in open-loop maneuvers. Launch vehicles frequently use open-loop attitude control during first stage atmospheric flight and closed-loop control computing optimal control solutions to achieve the desired end state (e.g., position and velocity at some future epoch, but without any predetermined trajectory or specified arrival time).

Some embodiments provide position and velocity feedback as well as feedforward acceleration to a guidance, navigation, and control (GNC) controller via continuous polynomial reference segments. Existing corridor control methods (e.g., International Space Station final docking) and guiding vector field (GVF) techniques do not offer the feedforward component provided by the predetermined multi-segment trajectory, thus requiring much higher control gains than are used in some embodiments. GVFs are complicated to describe, whereas the polynomial functions are very simple and easy to apply. Some embodiments do not require continuous re-calculation of the guidance trajectory (as is required for typical second stage boosters). Some embodiments precompute the trajectories for the multi-segment sequence once for feedforward control, and the space vehicle tracks its position, velocity, and acceleration via closed-loop feedback translational control.

According to some embodiments, complex launch vehicle and/or spacecraft orbit control sequences are achieved by stitching together finite open-loop maneuvers represented as polynomial sets that are tracked via real time closed-loop translation control GNC algorithms. According to some embodiments, precise orbital maneuvers can be achieved by uploading a continuous planned trajectory to the spacecraft. For example, one method for specifying a continuous multi-segment trajectory reference is via polynomial functions. The polynomial functions may fully define the position, velocity, and acceleration at any given instant in time, addressing the ambiguity and errors of time arising from strictly accelerometer-based implementations. According to some embodiments, a closed-loop controller can track all three states (position, velocity, and acceleration), using a combination of feedforward and real time feedback control algorithms. The algorithms can utilize various navigation sensors (in addition to an accelerometer) during execution, minimizing post-burn errors in the orbit. According to some embodiments, burns can also be executed in a relative frame, e.g., relative to a space station. According to some embodiments, navigation sensors can update the trajectory real-time during execution.

Some embodiments provide precision maneuvering for complex maneuver sequences by providing a continuous, trackable, translational reference, rather than relying on ground-based thrust calibrations for open-loop maneuvers. Some embodiments may be used for precision spacecraft orbit control. Some embodiments may be used for launch vehicles to add robustness against thruster variations, mass property uncertainty, and other uncertainties. Embodiments may allow for simpler thruster configurations.

Use of a multi-segment polynomial trajectory may describe continuous complex orbit maneuvering sequences as well as provide additional benefits (e.g., simpler propulsion system designs, robustness to uncertainties, lower bandwidth translational control, simple maneuver description model, computational simplicity, etc.).

These and other features and advantages are shown and described herein in reference to the figures.

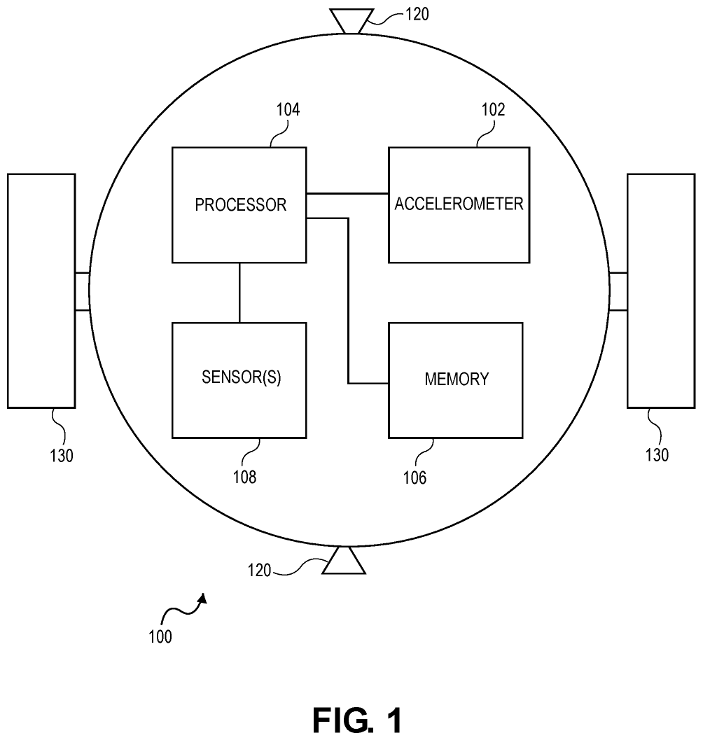

FIG. 1 is a schematic diagram of a space vehicle 100 according to various embodiments. The space vehicle 100 may be a satellite, for example. By way of non-limiting example, the space vehicle 100 as shown in FIG. 1 includes solar panels 130 to supply or supplement power, and thrusters 120, to adjust the attitude and/or orbit of the space vehicle 100.

The space vehicle 100 includes a processor 104, which is communicatively coupled to an accelerometer 102, a memory 106, and one or more additional sensors 108. The memory 106 may be any type of persistent and/or transient memory, which may store instructions to control the processor to perform any of the techniques disclosed herein.

The accelerometer 102 can estimate acceleration in three dimensions, along any of three axes, e.g., an x-axis, a y-axis, and a z-axis. The accelerometer 102 may be implemented as an inertial measurement unit, e.g., a MEMS inertial measurement unit, by way of non-limiting example, which can additionally measure rotational rate in three dimensions, e.g., the rate of rotation about each of an x-axis, a y-axis, and a z-axis, which may represent roll, pitch, and yaw.

The one or more additional sensors 108 may include one or more navigational sensors. The one or more additional sensors 108 may include any, or any combination of a GPS sensor, a fiducial marker sensor, a star tracker, an earth sensor, and/or a ranging sensor. The ranging sensor can be any of a variety of types, such as, by way of non-limiting examples: an active sensor (e.g., RADAR or LiDAR) or use a passive technique that uses an optical sensor e.g., (photometric light curves or a camera together with an object recognition algorithm that may use artificial intelligence, machine learning, etc.). The one or more additional sensors 108 may provide information regarding the absolute or relative position of the space vehicle 100. A fiducial marker sensor and/or range finder are particularly relevant to relative positional determinations, e.g., docking at a space station, which may display a fiducial marker.

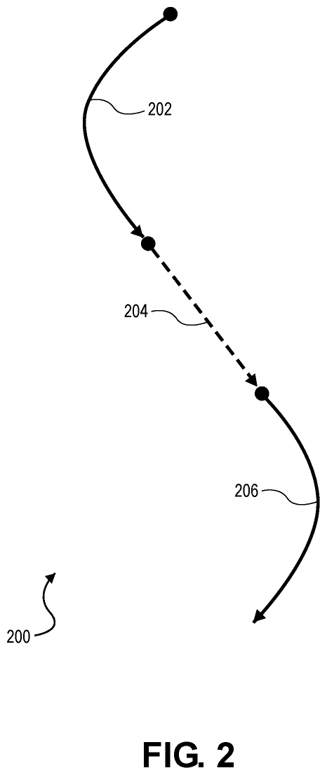

The memory 106 may store a representation of a multi-segment planned position, planned velocity, and planned acceleration of the space vehicle along a planned continuous trajectory of the space vehicle 100. A detailed example is shown and described herein in reference to FIG. 2.

The processor 102 may execute an open-loop feedforward algorithm, which may control the thrusters 120 to perform ΔV maneuvers to achieve the multi-segment planned position, planned velocity, and planned acceleration of the space vehicle. The ΔV maneuvers may be planned ahead of the traversal of the trajectory by the space vehicle 100, and may not change during the traversal of the trajectory.

The processor 104 may execute a closed-loop controller, which adjusts a position, velocity, and/or acceleration of the space vehicle 200, e.g., using burns of the thrusters 120, based on feedback received from the accelerometer 102 and/or additional sensor(s) 108. For example, the closed-loop controller may determine, based on the accelerometer 102 and/or additional sensor(s) 108, that the space vehicle 100 has deviated from one or more of the planned position, planned velocity, and/or planned acceleration. The closed-loop controller may accordingly control the thrusters at various times to implement corrections, e.g., as described in detail in reference to FIG. 2.

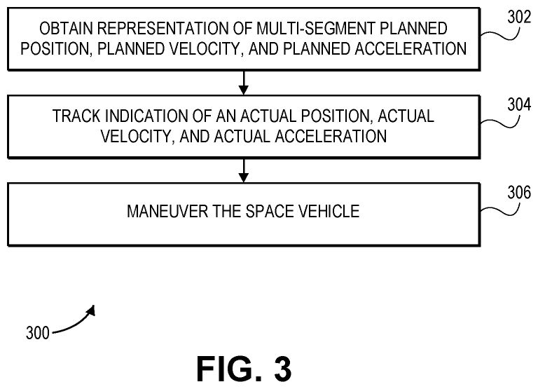

FIG. 2 is a schematic diagram of a planned continuous trajectory 200 of a space vehicle according to various embodiments. The trajectory 200 includes multiple segments 202, 204, 206, which represent a planned position, planned velocity, and planned acceleration. By way of non-limiting example, three segments are depicted in FIG. 3; however, embodiments may embrace any number of segments.

The trajectory 200 may be represented using multiple sets of polynomials. Each set of polynomials may represent one segment of the trajectory 200. By way of non-limiting example, each set of polynomials may include a polynomial that represents a position, velocity, and acceleration with respect to an x-axis, a polynomial that represents a position, velocity, and acceleration with respect to a y-axis, and a polynomial that represents a position, velocity, and acceleration with respect to a z-axis. For example, each set of polynomials may be of the form (x(t)=Σᵢ₌₀^{k}aᵢtⁱ, y(t)=Σᵢ₌₀^{k}bᵢtⁱ, z(t)=Σᵢ₌₀^{k}cᵢtⁱ), where t represents time, the term x(t) with coefficients aᵢ (for i=0, . . . , k) represents position with respect to the x-axis, the term y(t) with coefficients bᵢ (for i=0, . . . , k) represents position with respect to the y-axis, the term z(t) with coefficients cᵢ (for i=0, . . . , k) represents position with respect to the z-axis, and k represents a degree of the polynomials. The degree may be any positive integer, by way of non-limiting example, any number between 5 and 20. The position polynomials represent not only the position, but also the velocity and the acceleration of the space vehicle. In particular, the calculus first derivative of the polynomials represent the velocity of the space vehicle, and the calculus second derivative of the polynomials represent the velocity of the space vehicle.

The trajectory 200 may be uploaded to a space vehicle, e.g., the space vehicle 200 as shown and described herein in reference to FIG. 1. The trajectory 200 may be uploaded in the form of sets of polynomials, e.g., the coefficients thereof, where each set of polynomials represents one segment of the trajectory 200. These data may be stored in a persistent electronic memory, such as the memory 106 as shown and described herein in reference to FIG. 1. The trajectory 200 may be uploaded to the space vehicle prior to its embarking on a traversal of the trajectory, e.g., while the space vehicle is on the ground.

For the example shown in FIG. 2, the first segment 202 and third segment 206 represent burns of the space vehicle, where the space vehicle performs ΔV maneuvers using its thrusters. The second segment 204 represents a drift portion of the trajectory 200, which does not include planned burns of the space vehicle's thrusters. According to some embodiments, adjustments to the space vehicle's actual position, velocity, and/or acceleration may be made during such a drift portion. In more detail, during execution of the first segment 202, a closed-loop control may follow the trajectory, but errors may still accumulate. During the drift segment 204, the space vehicle has an opportunity to “clean up” its trajectory with small adjustment burns and converge back onto the desired drift trajectory, eliminating the need to plan and execute subsequent correction burns.

FIG. 3 is a flow chart illustrating a method 300 of maneuvering a space vehicle according to various embodiments. The method 300 may be implemented by a space vehicle, such as the space vehicle 100 as shown and described herein in reference to FIG. 1.

At 302, the method 300 includes obtaining a representation in a computer of a multi-segment planned position, planned velocity, and planned acceleration of the space vehicle along a planned continuous trajectory. According to some embodiments, the representation may be in the form of polynomials or their coefficients, as described in reference to FIG. 2. According to some embodiments, the space vehicle obtains the representation prior to implementation of the method 300, e.g., prior to its departure or prior to its beginning traversal of the trajectory.

At 304, the method 300 includes tracking, using at least one navigation sensor, an indication of an actual position, actual velocity, and actual acceleration of the space vehicle. The at least one navigation sensor may include an accelerometer, such as the accelerometer 102 as shown and described in reference to FIG. 1, and at least one additional sensor, such as the sensor(s) 108 as shown and described herein in reference to FIG. 1. The velocity and/or position, or initial approximations thereof, may be indicated by integrating an acceleration determined by the accelerometer, according to some embodiments. The initial approximations of velocity and/or position may be refined based on one or more additional sensors.

At 306, the method 300 includes maneuvering the space vehicle, using a closed-loop controller, and based on the tracking, to return to the planned position, planned velocity, and planned acceleration. The maneuvering may be performed using a closed-loop controller implemented by a processor and thrusters, such as the processor 104 and thrusters 120 as shown and described herein in reference to FIG. 1. The closed-loop controller may execute one or more closed-loop translation control GNC algorithms to perform the maneuvering.

Thus, a system and method for maneuvering a space vehicle is disclosed. Various embodiments may provide a continuous open-loop control reference (in position and velocity reference) that can be tracked by closed-loop GNC translational control algorithms. The use of polynomials to express the trajectory position, velocity, and acceleration profile as function of time allows for any number of maneuver sequences to be stitched together (with no discontinuities in position and velocity) to perform automated complex orbital maneuvering. By closed-loop tracking the polynomial functions, the system can off pulse and still precisely closed-loop track the prescribed trajectory.

Embodiments may be used in a variety of contexts for a variety of purposes including, by way of non-limiting examples: precision satellite repositioning, precision satellite cluster operations, spacecraft rendezvous, proximity and docking operations (e.g., space station docking, on-orbit refueling), launch vehicle upper stage maneuvering, and other applications.

Various embodiments provide a relatively simple approach to automated precision orbital control maneuvering, precision satellite cluster reconfiguration, launch vehicle guidance, and rendezvous and proximity operations. Some embodiments provide both improved precision and robustness in comparison to traditional approaches, and can be used with simpler propulsion system designs.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform]ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A non-transitory computer readable medium comprising instruction that, when executed by an electronic processor, configure the electronic processor to implement a method of maneuvering a space vehicle by performing actions comprising:
obtaining a representation in a computer of a multi-segment planned position, planned velocity, and planned acceleration of the space vehicle along a planned continuous trajectory;
tracking, using at least one navigation sensor, an indication of an actual position, actual velocity, and actual acceleration of the space vehicle; and
maneuvering the space vehicle, using a closed-loop controller, and based on the tracking, to return to the planned position, planned velocity, and planned acceleration.

2. The computer readable medium of claim 1, wherein the representation comprises a plurality of polynomial segments.

3. The computer readable medium of claim 1, wherein the at least one navigation sensor comprises at least one of: a GPS sensor, a fiducial marker sensor, a star tracker, an earth sensor, or a range finder.

4. The computer readable medium of claim 1, wherein the planned continuous trajectory comprises an orbit of the space vehicle about a planet.

5. The computer readable medium of claim 1, wherein the planned continuous trajectory comprises a docking of the space vehicle with another space vehicle.

6. The computer readable medium of claim 1, wherein the multi-segment planned position, planned velocity, and planned acceleration comprises a burn segment and a drift segment, and wherein the maneuvering occurs during the drift segment.

7. The computer readable medium of claim 1, wherein the tracking comprises using feedback data and feed-forward data.

8. The computer readable medium of claim 1, wherein the obtaining occurs prior to beginning traversal of the planned continuous trajectory.

9. The computer readable medium of claim 1, wherein the maneuvering corrects for an accelerometer inaccuracy.

10. The computer readable medium of claim 1, wherein the at least one navigation sensor comprises an on-board sensor.

11. A system for maneuvering a space vehicle, the system comprising:
an electronic processor; and
a non-transitory computer readable communicatively coupled to the electronic processor, the non-transitory computer readable medium comprising instructions that, when executed by the electronic processor, configure the electronic processor to perform actions comprising:
obtaining a representation of a multi-segment planned position, planned velocity, and planned acceleration of the space vehicle along a planned continuous trajectory;
tracking, using at least one navigation sensor, an indication of an actual position, actual velocity, and actual acceleration of the space vehicle; and
maneuvering the space vehicle, using a closed-loop controller, and based on the tracking, to return to the planned position, planned velocity, and planned acceleration.

12. The system of claim 11, wherein the representation comprises a plurality of polynomial segments.

13. The system of claim 11, wherein the at least one navigation sensor comprises at least one of: a GPS sensor, a fiducial marker sensor, a star tracker, an earth sensor, or a range finder.

14. The system of claim 11, wherein the planned continuous trajectory comprises an orbit of the space vehicle about a planet.

15. The system of claim 11, wherein the planned continuous trajectory comprises a docking of the space vehicle with another space vehicle.

16. The system of claim 11, wherein the multi-segment planned position, planned velocity, and planned acceleration comprises a burn segment and a drift segment, and wherein the maneuvering occurs during the drift segment.

17. The system of claim 11, wherein the tracking comprises using feedback data and feed-forward data.

18. The system of claim 11, wherein the obtaining occurs prior to beginning traversal of the planned continuous trajectory.

19. The system of claim 11, wherein the maneuvering corrects for an accelerometer inaccuracy.

20. The system of claim 11, wherein the at least one navigation sensor comprises an on-board sensor.
